(19) United States
(12) Patent Application Publication
(10) Pub. No.: US 2018/0344058 A1
(43) Pub. Date: Dec. 6, 2018

(54) HAT HOLDER AND MERCHANDISE DISPLAY UNIT

(71) Applicant: Robert Petner, Burlington, NJ (US)

(72) Inventor: Robert Petner, Burlington, NJ (US)

(21) Appl. No.: 15/997,823

(22) Filed: Jun. 5, 2018

Related U.S. Application Data
(60) Provisional application No. 62/515,804, filed on Jun. 6, 2017.

(51) Int. Cl. A47F 7/06; A47G 25/10

(52) U.S. Cl. CPC A47F 7/06; F16M 13/02; A47G 25/10

(57) ABSTRACT

A hat holder and merchandise display unit has a hat holder member with a curved hat brim supporting section and a vertical wall section perpendicular with and extending downwardly from the hat brim supporting section. The wall section of the hat holder member has a central slot bordered by inwardly extending sidewalls configured to accept an attachment tongue from a merchandise display member having a display section. Once the attachment tongue of the merchandise display member is positioned within the wall section slot, the merchandise display member is rigidly secured to the hat holder member to form a single hat holder and merchandise display unit.

### RELATED APPLICATION

This application claims the benefit of provisional application 62/515804 filed on Jun. 6, 2017.

### BACKGROUND OF THE INVENTION

Many value conscience consumers are anxious to examine products that they may be interested in buying and, at the same time, they often want a brief description of the product, including, of course, its price. There are numerous merchandise display systems which attempt to accomplish these objectives. However, many of these tend to constitute either large bulky displays or small ones which provide little or incomplete information. Moreover, there are no merchandise display systems specifically for hanging and holding hat products, for providing a means to show information about the products, and which are lightweight, portable, and are removable for reuse.

### SUMMARY OF THE INVENTION

It is thus the object of the present invention to provide a hat holder and merchandise display unit which addresses the disadvantages and limitations of existing display units, by providing a lightweight, reusable hat holder member and a merchandise display member combination which not only holds a hat to allow the consumer to clearly view it, but also has an information containing display section which is interchangeable with other display sections.

These and other objects are accomplished by the present invention, a hat holder and merchandise display unit having a hat holder member with a curved hat brim supporting section and a vertical wall section perpendicular with and extending downwardly from the hat brim supporting section. The wall section of the hat holder member has a central slot bordered by inwardly extending sidewalls configured to accept an attachment tongue from a merchandise display member having a display section. Once the attachment tongue of the merchandise display member is positioned within the wall section slot, the merchandise display member is rigidly secured to the hat holder member to form a single hat holder and merchandise display unit.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is a front isometric view of the hat holder member of the present invention.

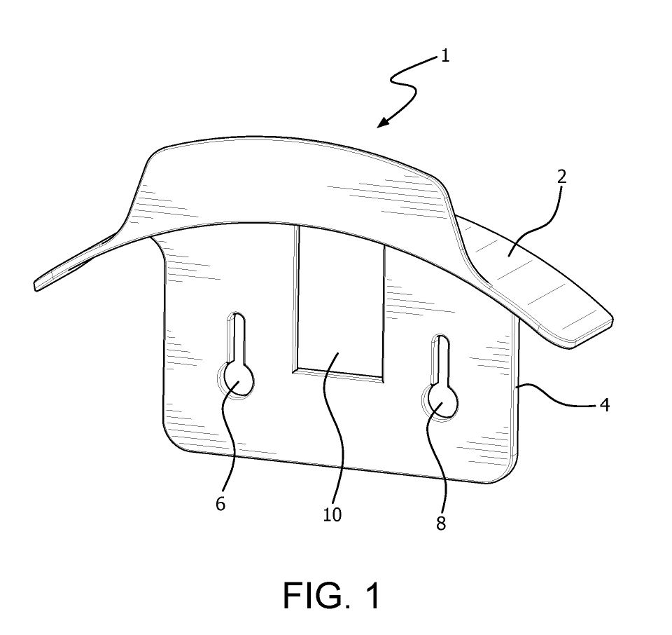

FIG. 2 is a rear isometric view of the hat holder member of the present invention.

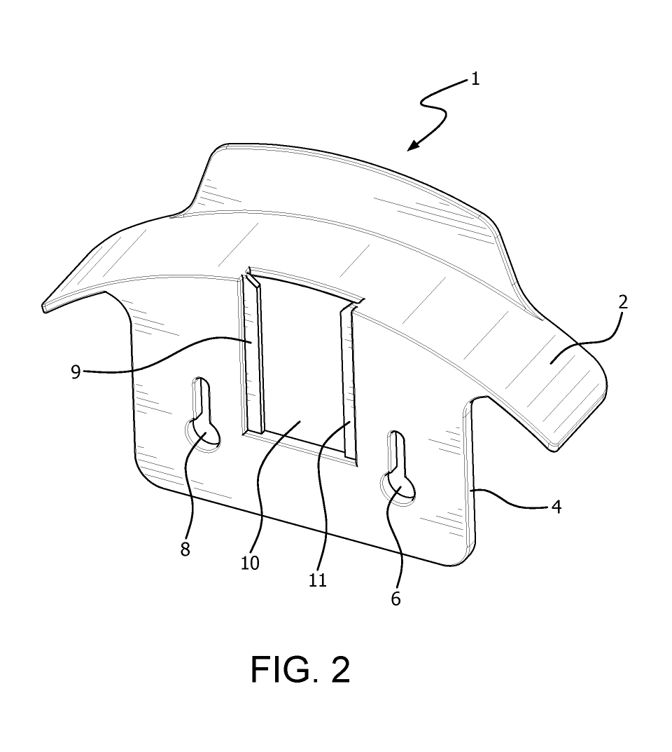

FIG. 3 illustrates the merchandise display member in position for attachment to the hat holder member.

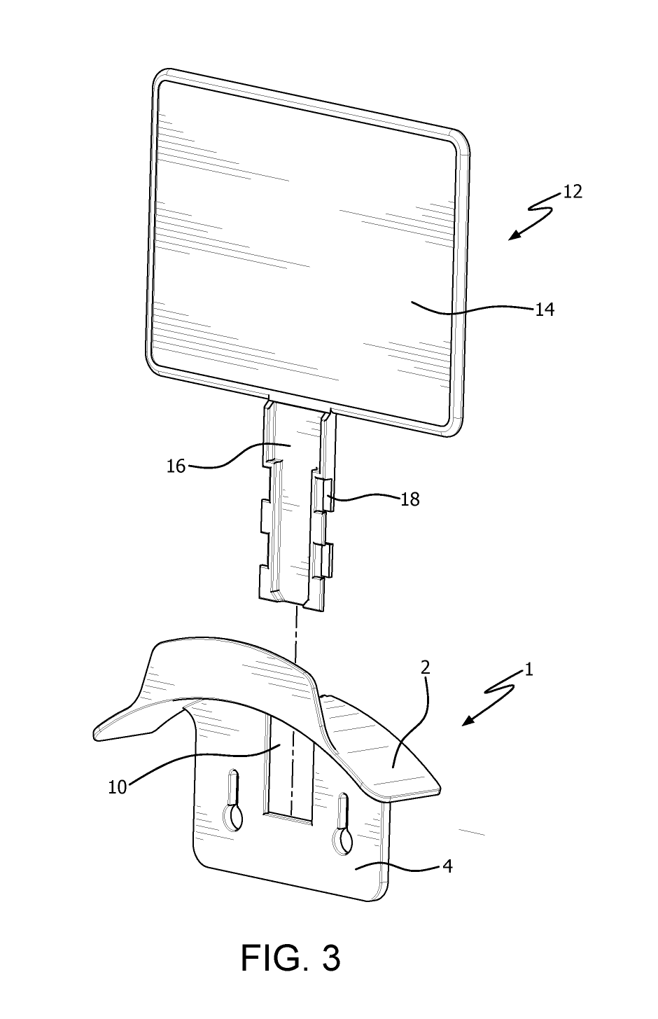

FIG. 4 is another isometric drawing of the hat holder member and merchandise display member of the present invention in their connected configuration.

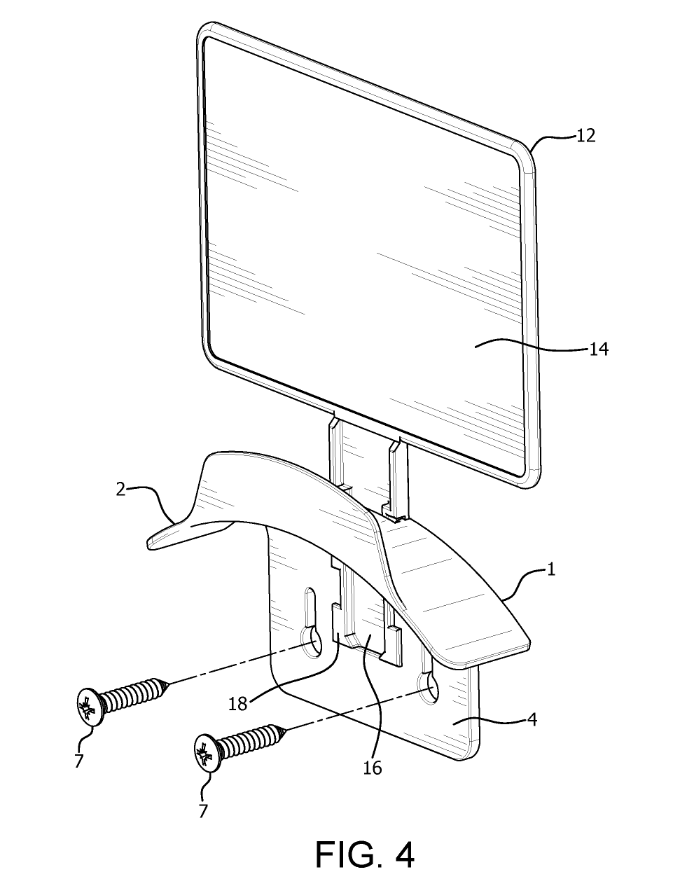

FIG. 5 is a front drawing of the hat holder member and merchandise display member of the present invention in their connected configuration.

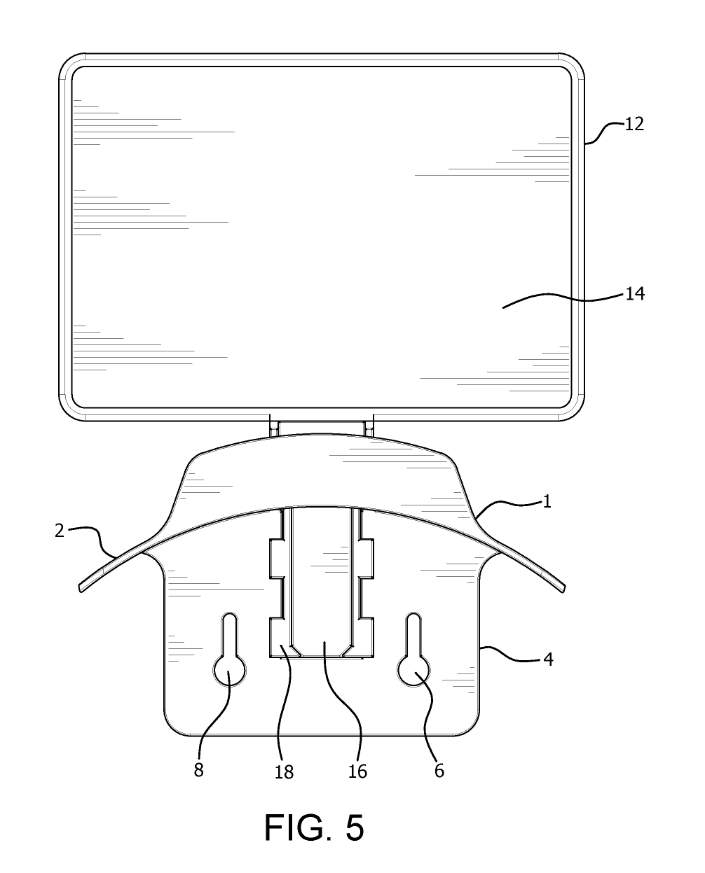

FIG. 6 is an elevation drawing of the hat holder member and merchandise display member of the present invention in their connected configuration.

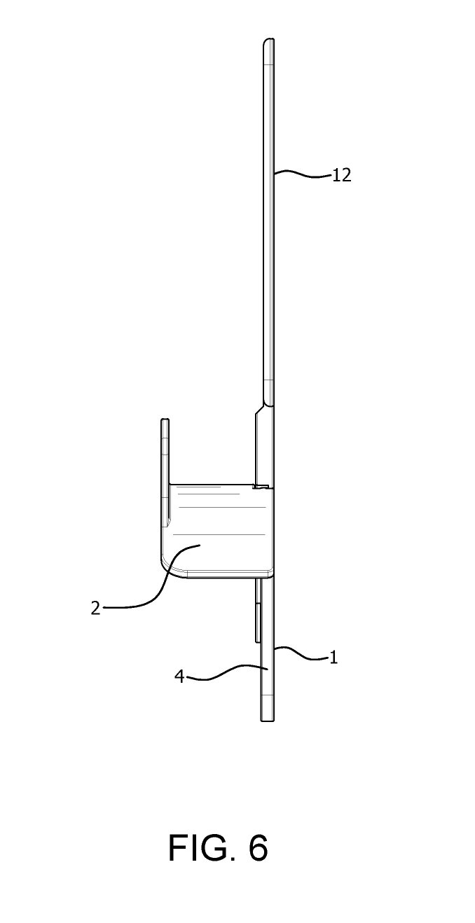

### DETAILED DESCRIPTION OF THE INVENTION

Hat holder member 1 is an integral body comprising curved, hat brim support section 2 and downwardly extending, vertical wall section 4 perpendicular to the hat brim support section. Openings 6 and 8 permit the insertion of screws or like attachment devices 7 to secure hat holder member 1 to a wall, frame, or other vertical surface. Center slot 10 extends into wall section 4. Slot 10 is bordered by side walls 9 and 11 which extend inwardly into slot 10.

Merchandise display member 12 comprises display section 14 and downwardly extending attachment tongue 16. Tongue 16 has a plurality of outwardly extending tab elements 18.

Tongue 16 of display member 12 is configured to be inserted and slid into slot 10 of wall section 4. When tongue 16 is positioned within slot 10, tab elements 18 hug sidewalls 9 and 11 of slot 10, thus rigidly maintaining the display member over hat holder member 1. The result is a single, stable and secured attached hat holder and merchandise display unit which allows a hat to be easily hung and displayed from support section 2 of hat holder member 1. A description of the hat, its price, and other information can be placed on signage included on display section 14 of display member 12.

It is apparent that the invention is quite versatile, in that not only can different hats be hung for viewing on hat holder member 1, but display member 12 is also interchangeable with alternate display units. Toward this end, display member 12 can easily be slid from slot 10 of the hat holder member, and it can be removed and replaced with a different display member with different signage.

The entire hat holder and merchandise display unit can easily be removed and repositioned by removing screws 7 and then reattaching them through openings 6 and 8 after positioning the unit in another location.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A hat holder and merchandise display unit comprising:
a hat holder having an integral body with a curved hat brim supporting section and a vertical wall section perpendicular with and extending downwardly from the hat brim supporting section, the wall section having a central slot bordered by inwardly extending sidewalls; and
a merchandise display member comprising a display section with a downwardly extending attachment tongue configured to be inserted and positioned within the wall section slot, whereby when the tongue is positioned within the slot, the merchandise display member is rigidly secured to the hat holder member.

2. The hat holder and merchandise display unit as in claim 1 wherein the attachment tongue has a plurality of outwardly extending tab elements, whereby when the attachment tongue is positioned within the slot, the tab elements hug the sidewalls of the slot to form the single hat holder member and merchandise display unit comprising the hat holder member and the merchandise display member.

3. The hat holder and merchandise display unit as in claim 1 wherein the wall section comprises openings to permit the insertion of attachment devices to secure the hat holder and merchandise display unit to a vertical surface.
